(19) United States
(12) Patent Application Publication
(10) Pub. No.: US 2006/0080228 A1
(43) Pub. Date: Apr. 13, 2006

(54) Home equity protection contracts and method for trading them

(76) Inventors: Bradley J. McGill, Birmingham, AL (US); C. Todd McCormick IV, New York, NY (US)

Correspondence Address: MERCHANT & GOULD PC, P.O. BOX 2903, MINNEAPOLIS, MN, 55402-0903, US

(21) Appl. No.: 10/938,743

(22) Filed: Sep. 9, 2004

(51) Int. Cl. G06Q 40/00

(52) U.S. Cl. 705/38

(57) ABSTRACT

A method for creating, marketing, and selling a contractual instrument for protecting a value characteristic of a homeowner's residential real estate property is provided according to the invention. The derivative instrument can be created in the form of a simple contract like a “Home Equity Protection Product” sold to the homeowner by a mortgage originator or P&C insurer. It provides a cash-settled payout to the buyer at a predetermined expiration date defined by the contract correlated to, e.g., the home's market value or home equity value, and a reduction in value of a benchmark real estate index between, e.g., the contract purchase date and the expiration date. The Home Equity Protection Contracts of the present invention may be securitized much like mortgage-backed securities on a secondary and sold to institutional investors to permit them to speculate in the value of residential real estate in order to broaden their investment portfolios.

### FIELD OF THE INVENTION

The present invention relates to a financial instrument called the “Home Equity Protection Product” (HEP) that enables home owners and lenders to hedge against a substantial decline in home equity value while creating an entirely new Mortgage Backed Security (MBS) for the MBS marketplace.

### BACKGROUND OF THE INVENTION

The value of residential real estate and land in the United States accounts for more than half of the national wealth. Homeownership has always been part of the “American Dream,” and it is an important societal goal in many other countries too. With the steadily rising values of housing markets, a home represents the largest single asset for most individuals, and the associated accumulated equity in the home constitutes a substantial part of their financial net worth.

Yet, such residential real estate holdings can suffer from the risk of downward price movement, as evidenced several times during the past two decades on the East and West coasts. Not only can this fact have an adverse effect upon the net worth of many homeowners, but also it can hurt builders and developers of residential properties as well as mortgage providers who are adversely affected by defaulting borrowers.

Despite the sophistication of the financial markets in the United States, there is still no financial product specifically designed to help home owners and lenders protect the value of this enormous asset class. Secondary financial products exist in virtually every sizable market and asset class and provide investors with alternative methods for investing and hedging their current position (e.g., the options market for equities, the futures market for commodities, and the treasuries markets for currencies). However, the only hedging mechanism that is really available for the residential real estate market are financial futures or options contracts based upon interest rates, which are indirectly associated with real estate values. Owners of residential real estate and mortgage lenders would therefore benefit greatly from a financial instrument that would directly hedge this risk. Indeed, several economic professors published papers in the early 1990's identifying the need for such hedging instruments, and generally calling for the availability of cash-settled futures or options contracts based upon unspecified indices of real estate prices. See Case, Jr., K. E., Shiller, R. J., and Weiss, A. N., “Index-Based Futures and Options Markets in Real Estate, (December 1991); Shiller, R. J. and Weiss, A. N., “Home Equity Insurance,” NBER Working Paper Series, Working Paper No. 4830 (1994). However this work did not define how such products could be made widely available to virtually all home owners while also securitizing these instruments and making them available to the MBS markets as a new type of MBS product. Thus, ten years later, there still is no efficient method for hedging real estate.

The only instance known to the inventors of any attempt to provide such a financial instrument was a futures contract on residential real estate prices in the United Kingdom that was initiated by the London Futures and Options Exchange (London Fox) in May 1991. Trading in this contract was promptly suspended in October 1991, however, when it became apparent that few homeowners were availing themselves of an exchange-based system despite the presence of unstable residential real estate prices in England, and the exchange had artificially supported trading values in the futures contract to mask this deficit in customer usage.

Other historic examples of products for protecting equity in residential real estate would be the cities of Oak Park and Chicago in Illinois that started special “equity assurance” programs back in the 1980's and 1990's to protect house values from declines under certain very narrow circumstances. However, these programs were directed to changes in neighborhoods as the racial demographics evolved, not larger fluctuations in real estate values as a whole. Because it was difficult for a homeowner to prove that the decline in value of his home was caused by such racial changes in his neighborhood, as opposed to other market forces, in order to invoke coverage, these programs suffered from relatively low participation levels.

To purchase a home buyer will typically take out a loan, called a mortgage for the purchase price less the amount the buyer is able to pay immediately in cash. Typically this cash down-payment is twenty percent (20%) or more of the total price of the home, but it can be as little as zero percent (0%). Home owners who pay less than 20% of the total price at purchase are required to pay an additional mortgage insurance fee each month as part of their mortgage payment. The total price of the home, less the amount the home owner still owes on the mortgage at any given time represents the equity of the home owner. Thus, equity is, in essence, the amount of cash the home owner has invested in their home and it typically represents a large portion of the individuals total net worth and is even often used as a means against which home owner's borrow additional money (this is often call a “2nd mortgage”). The homeowner may also be required to purchase “home mortgage insurance” if the down payment that he makes for the house amounts to less than, e.g., 20% of the purchase price. The homeowner will therefore make an additional payment to the mortgage bank each month for this insurance policy that is meant to insure the bank against a default on the mortgage by the home owner. Finally, the home owner will be required by the bank to take out “homeowners insurance” on the house. However, this policy only provides protection against damage or destruction to the house due to fire or other physical disaster, and does not cover the often greater risk of declining value of the house due to market forces.

While there has been a market demand for many years for additional insurance coverage against market declines in house values, insurance companies have been reluctant to write such home equity insurance policies for a variety of reasons.

First, an insurance policy that directly protect against a decline in a particular home's value is one of “moral hazard,” since many factors influencing the value of a home are under the direct control of the homeowner. If the homeowner fails to adequately maintain the house and property, or makes decorative or other changes that are idiosyncratic in nature, then a decline in the value of the property will inevitably result. Yet, it would be difficult for an insurance company to objectively prove under some default provision in the insurance policy what portion of the house's reduced sale price was due to any of these “home owner controlled” factors. Thus, a home owner with a home equity insurance policy would be temped to fail to maintain the property because he would face no financial risk.

A second problem is that buyers of homes who paid too much for the property would have a special incentive to take out a home equity insurance policy due to the probability that they could not sell the house for the same price, at least within the relatively near future. This is called the “adverse selection problem.” A home equity insurance policy would therefore place this risk squarely on the insurance company. A third and related problem would be a home equity insurance policy holder who neglected to make reasonable efforts to obtain market value for his house at the time of sale because they know the insurance company would make up the difference. These reasons have made home equity insurance policies unfeasible.

Moreover, it would be very beneficial to the homeowner if this derivative instrument could adopt the form of a contract that would be sold to him by his mortgage originator or P & C insurer, as opposed to complex financial security that needs to be traded on a financial exchange.

### SUMMARY OF THE INVENTION

A method for creating and marketing a derivative instrument for protecting a value characteristic of a homeowner's residential real estate property is provided according to the invention. The derivative instrument can be created in the form of a simple contract like a “Home Equity Protection Product” sold to the homeowner by a mortgage originator or P&C insurer. It provides a cash-settled payout to the buyer at a predetermined expiration date defined by the contract correlated to, e.g., the home's market value or home equity value, and a reduction in value of a benchmark real estate index between, e.g., the contract purchase date and the expiration date. The Home Equity Protection Contracts of the present invention may be securitized much like mortgage-backed securities on a secondary and sold to institutional investors to permit them to speculate in the value of residential real estate in order to broaden their investment portfolios.

### BRIEF DESCRIPTION OF THE DRAWINGS

In the accompanying drawing:

FIG. 1 is a schematic showing the method of the invention for creating and marketing residential real estate derivatives.

### DETAILED DESCRIPTION OF THE PREFERRED EMBODIMENT

These and other objectives are achieved by the present invention, a “Home Equity Protection Product” (HEP), which is a cash settled financial instrument that is based on an underlying index or data point of similarly priced residential real estate properties, or some other underlying factor impacting residential real estate. The HEP will protect home owners by repaying them all or a substantial portion of any loss in the value of their home equity

For purposes of this application, “residential real estate” means owner-occupied residential dwellings, including but not limited to houses, townhouses, condominiums, owned apartments, and co-ops.

The natural buyers of the HEP are residential property owners and lenders. The invention calls for the home owner to pay an additional fee each month as part of their mortgage payment to purchase the HEP. The HEP will then protect the home owner's equity in the event of a decline in the value of the HEP's underlying index by a particular amount or a particular percentage, as set by the HEP's strike value, before the HEP's expiration date which would typically coincide with the mortgage's duration. If, upon expiration, the index value has fallen to or below the strike value, then the HEP would be “in the money,” and pay the home owner back all or a portion of the equity lost. On the other hand, if, upon expiration, the index value was still above the strike value, then the HEP would simply expire with no payment due to the home owner.

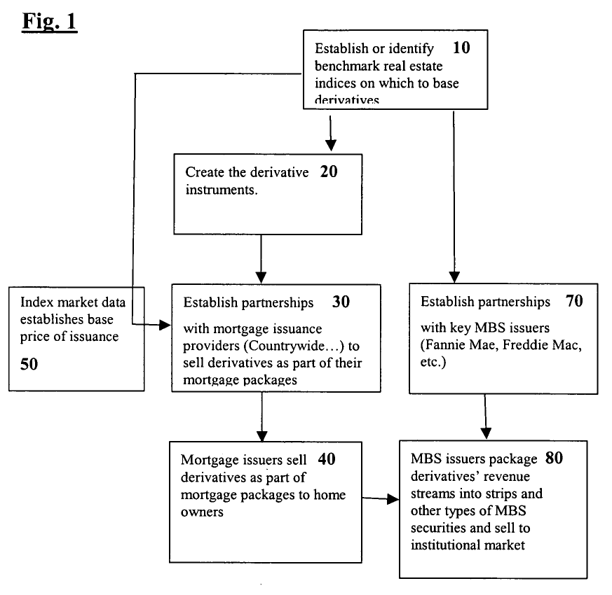

The method for developing a market for such residential real estate derivatives is illustrated by the flow chart in FIG. 1. Step 10 involves the compilation of a benchmark index of pertinent residential real estate values. There are available data providers for residential real estate, including the HUD's extensive American Housing Survey (AHS), the Federated Housing Authority (FHA), and the Federal Government's Department of Housing and Urban Development (“HUD”), Case, Shiller, Weiss, or a similar Property Valuation Company. Otherwise, a suitable index can be customized to fit the parameters of the particular residential real estate of interest. This could be done in conjunction with Standard & Poors or one of the other ratings agencies, or with investment banks like Credit Suisse First Boston who are experienced in creating indices, and who have expertise and credibility in the real estate ratings industry.

The index would provide a composite value for a specific type of residential property, such as single-occupancy homes, townhouses, condominiums, or owned apartments. The index may also characterize the properties within a specific price target. Too broad of inclusion of residential property types may diminish the role of the index as an indicator of changes in property values, thus the index will likely break up the property types on the basis of geography, such as a metropolitan area, zip code, township, or city, and by price range. In this manner, the index may be used to provide a clear and concise understanding of the changes in values, e.g., of “Single-Occupancy Homes in the 55359 zip code between $200,000-300,000” or “Condominiums in Manhattan, N.Y. above $1 million.”

By basing the HEP on a change in value of the index, as opposed to the change in value of the derivative owner's own residence, the moral hazard and adverse selection problems that have discouraged insurance companies from offering house equity insurance policies are eliminated.

There are a number of considerations that should be taken into account in choosing or constructing an appropriate residential estate index that can provide a suitable basis for an underlying benchmark for the HEP. First, the index obviously needs to include data points that are relevant for the property's type and geography. Otherwise, the index will not serve its role as a determiner of the value of the HEP. Second, the index should provide a credible representation of changes in the property values. Appraised values are often the most readily available property data on a broad basis, but data from actual real estate property transactions could be preferred. Third, the creator of the index must appropriately classify the underlying real estate assets for the resulting compiled data to have validity.

Fourth, the index should incorporate a larger number of underlying data points when calculating composite values. This is critical so that no smaller subset of buildings or property owners could, themselves, skew the entire index. Fifth, the index must be accepted as a valid measurement of underlying real estate values. It may therefore, be better if the index is compiled by a government agency or a well-known recognized industry association

For these reasons, the preferred index for use in association with the residential real estate derivatives of the present invention is the “American Housing Survey” compiled and issued by HUD.

Step 20 shown in FIG. 1 involves the creation of the HEP. The HEP must identify an expiration date that would prompt a payout if the HEP's underlying index or data point was at or beneath the HEP's strike value. The logical expiration point would be the home owner's final mortgage payment date, and/or any time at which the buyer of the HEP sells the home, since it is at this point that he would truly suffer from any depreciation in the value of his property. The HEP's price, and subsequent monthly cost to the buyer would be based on numerous factors, including, for example, if the home was purchased during a downward price trend in the market for the property type. In this declining market, the risk would be greater that the HEP's underlying index or data point would decline to the strike value, especially if the property were sold within the near future. Thus, this HEP would be more expensive than a HEP purchased in an upward market trend. A longer time period, on the other hand would decrease the risk of the HEP expiring at or below the strike value, and would thus decrease the cost of the HEP. In addition, just like mortgage insurance payments, the price of the HEP, and subsequently the HEP's monthly cost, could be adjusted by the issuer on an annual basis to adjust for current market conditions, thereby making the HEP more or less expensive, depending on current market conditions and trends.

Next, the HEP would need to define the payout based upon the home owner's current equity and the HEP's strike value. There are numerous possibilities for the payout structure. The payout might cover, for instance, the entire percentage decline of the index between the HEP purchase and expiration dates, multiplied by the home owner's current equity. For example, if the HEP's strike value was 20%, and the HEP value on the purchase date was 1,000, then upon the expiration date, if the HEP value is 800 or less, the HEP would pay the home owner their total equity, multiplied by 0.2 (20%). Thus, if the home owner had $20,000 of equity in their home, the HEP would pay them $20,000×0.2=$4,000. Other alternatives include a capped HEP, where the HEP could be defined to cap the buyer's cash settlement at a certain dollar amount. There are a number of other possibilities for defining the HEP payout, and each such cash settlement structure will entail different relative risk and reward profiles for the buyers and seller of the instrument, and thus command different appropriate pricing.

Yet another factor for defining the residential HEP is the time point at which the HEP is purchased. Typically, the buyer may want to acquire the HEP at the time that he purchases his home. Another logical point would be the time at which he refinances his mortgage. Other pre-determined points for buying the HEP are possible since the value of the HEP is defined by the value of the underlying benchmark index or data point at the time of purchase, then it may not particularly matter from the seller's perspective when the HEP is purchased by the buyer.

Ideally, the value of the HEP should be indexed for inflation, as measured by a cost of living index like the Consumer Price Index. In this manner, the HEP would protect against real loss in value of the equity, not its nominal loss, the extent of which may be hidden over time by inflation.

A HEP's premium, which is the price that the buyer of the HEP must pay to the seller for the financial protection the HEP offers to the buyer, and to compensate the seller for the risk that he is taking considering he may have to pay the buyer back for his loss in equity value upon expiration if the HEP's underlying index or data point is at or below the strike value. In general, this purchase price will take into account the payout structure of the HEP, including the conditions for that payout and the time period until expiration, as well as the history of price movements in the relevant real estate type and geography, including volatility thereof, as reflected by the HEP's underlying index.

Step 30 of the present invention shown in FIG. 1 comprises the establishment of partnerships with parties who can act as sellers of the HEPs. These parties typically will be large mortgage issuance providers like Countrywide Mortgage or Washington Mutual, or P&C insurers like Allstate or State Farm. The principal advantage of having mortgage originators or P&C insurers sell the HEPs to the homeowner (Step 40) is that they already are interacting with the home owner at the same time that he takes out the mortgage or homeowner's insurance on his residential real estate property. There will therefore be no need for the house purchaser to take the initiative to go to a financial institution to purchase a listed put option or short futures contract, which he is unlikely to do, as evidenced by the failure of the London (Fox) Exchange in the United Kingdom. Another advantage of using a mortgage originator or P&C insurers as sellers of the HEP is that they can simply integrate the HEP into the mortgage and the buyer's subsequent mortgage payments.

The retail sale of thousands or millions of these HEPs by mortgage originators or P&C insurers would generate a substantial monthly flow of premium income, as well as contingent liability against falling residential real estate prices, which would be borne by those same institutions as the seller of the HEP. Therefore, the mortgage originators or P&C insurers could choose to diversify their risk by transferring both the income and liability streams from these derivatives to willing buyers on a secondary market. Step 70 of FIG. 1 therefore entails the establishment of a partnership with key mortgage-backed securities (“MBS”) issuers like Fannie Mae and Freddie Mac, who can then repurchase large numbers of these HEPs from the mortgage originators and P&C insurers, much as they currently do for mortgages. Then, under Step 80, they can securitize the revenue and liability streams from these HEPs into different issuances of strips and other MBS types according to risk profile, geographic exposure, home price, exposure, duration, etc., and sell them to the REITs, financial institutions, and pension funds, just as they do currently with all their MBS products. The purchase of these securitized HEPs would provide a way for these institutional investors to obtain returns of real estate investment and ownership on a synthetic basis, and a way for financial institutions such as hedge funds and endowments to speculate on prices in the residential real estate market, treating these HEPs as as a new trading opportunity in a unique class. Thus, investors and speculators taking a long position in these HEPs would enjoy the benefits of “owning” the real estate market without the costs, illiquidity, and supply constraints of direct ownership. They would be betting that the real estate values would go up or at least hold steady, so the HEP's underlying index would not decline to the HEP's strike value and force them to payout on the HEPs.

Although these securitized contracts would provide a stream of income, like MBS tranches, their risk profile would be quite different. Rather than pre-payment risk, which is defined by interest rates, the holder of these notes would be accepting residential real estate value risk. This is the inverse of the pre-payment risk adopted by MBS investors, which is subject to falling interest rates. In general, home values would be expected to fall in a rising interest rate environment (except in the event of a massive deflationary cycle), thereby creating a complementary risk profile, and adding to the attractiveness of this product to institutional investors.

In addition, the termination of coverage of an individual HEP contract, whether due to a move or mortgage refinancing, would remove any contingent liability from the institutional investor who has bought these securitized HEPs, thereby leaving the institutional investor with the prior stream of income, which has been purely profitable. This would compare favorably with the pre-payment risk characteristic for MBS instruments, which typically occur due to refinancings by home owners in declining interest rate environments. This pre-payment consideration poses reinvestment risk, and is generally seen as a negative by the mortgage community.

By purchasing these securitized HEPs, the institutional investors are effectively transferring home price risk from an average citizen to themselves, much as they currently due for home mortgages. By further supporting the home equity market, they would be providing a valuable societal benefit.

Yet a further benefit of the residential real estate derivatives of the present invention is the opportunity to help home owners liquify the otherwise dormant home equity in their properties for productive investment in other asset classes. More specifically, once an individual has effectively guaranteed a minimum value of his home equity through purchase of a HEP, it becomes much more attractive for the home owner to unlock the otherwise illiquid value of this real estate equity in order to augment his personal investment portfolio. This home owner could borrow against his now guaranteed equity value at a low, tax-advantaged interest rate, and diversify and leverage his portfolio. The bank would be more willing to make the loan, because the collateral value supporting the loan would be guaranteed by the HEP. Depending upon the prevailing interest rate environment, an investor could reasonably and prudently invest in a range of financial instruments that would leverage his total return without incurring undue financial risk that might lead to the loss of his home. Such investments could include U.S. Treasury, agency, or high-quality corporate bonds with a maturity matched to the term of his second mortgage (i.e., the bank loan), guaranteed investment contracts, principal-protected notes or annuity contracts offering exposure to the equity market, or other financial investment products designed specifically for such transactions.

By guaranteeing the collateral value, it would be much less expensive and risky for the home owner to leverage his accumulated home equity in this manner to make financial investments that he otherwise could not afford. This strategy, if appropriately marketed through retail market channels, could effectively unlock much of the trillions of dollars in accumulated home equity in the U.S. for productive reinvestment in the economy and capital markets, thereby providing a low-cost, low-risk arbitrage opportunity for ordinary home owners to increase their cash flow or leverage their largest asset in order to increase their personal wealth.

The above specification, examples, and data provide a description of the invention relating to commercial real estate derivatives. Since many embodiments of the present invention can be made without departing from the spirit and intended scope of the invention, the invention resides in the claims hereinafter appended.

We claim:

1. A method for creating and selling a financial security for protecting a value characteristic of a homeowner's residential real estate property, comprising:
(a) establishing or accessing a benchmark index that characterizes the value of a plurality of residential real estate properties of the same type as the homeowner's property;
(b) establishing a financial security based upon the benchmark index for that particular type of real estate property having a first value at a first time, the financial security having an expiration date, and defining a cash-settled payout correlated to the value characteristic of the homeowner's property at the first time, and a reduction in value of the index between the first time and the expiration date;
(c) selling the financial security to the homeowner in return for a purchase price;
(d) securitizing the financial security along with other similar financial securities sold to other homeowners on a secondary market for purchase by buyers speculating in the value of residential real estate; and
(e) wherein the homeowner will receive the cash-settled payout on the expiration date if the value of the benchmark index has decreased between the first time and the expiration date.

2. The method of claim 1, wherein the cash-settled payout is further based upon the occurrence between the first time and the expiration date of an amount of reduction in value of the benchmark index beyond a predetermined minimum amount specified in the contract.

3. The method of claim 1, wherein the cash-settled payout is capped at a predetermined amount specified in the contract.

4. The method of claim 1, wherein the value characteristic of the homeowner's property is its market value.

5. The method of claim 1, wherein the value characteristic of the homeowner's property is the amount of home equity in such property.

6. The method of claim 1, wherein the property type is further defined by a geographic region.

7. The method of claim 1, wherein the benchmark index is the American Housing Survey compiled and issued by HUD.

8. The method of claim 1, wherein the property type is houses, townhouses, condominiums, owned apartments, or co-ops.

9. The method of claim 1, wherein the contractual instrument is sold to the homeowner by a mortgage originator.

10. The method of claim 1, wherein the contractual instrument is sold to the homeowner by a P&C insurer.
